(19) United States
(12) Patent Application Publication
(10) Pub. No.: US 2008/0284081 A1
(43) Pub. Date: Nov. 20, 2008

(54) Working surface for machine or workbench

(76) Inventor: Darrin Eugene Smith, Innisfil (CA)

Correspondence Address: Muncy, Geissler, Olds & Lowe, PLLC, P.O. BOX 1364, FAIRFAX, VA, 22038-1364, US

(21) Appl. No.: 12/153,246

(22) Filed: May 15, 2008

(30) Foreign Application Priority Data
May 16, 2007 (CA) 2,588,894

(51) Int. Cl. B23Q 1/25; B26D 7/01; B25H 1/00; B23Q 1/28; B25H 1/10; B23Q 1/44

(52) U.S. Cl. 269/74; 144/286.5; 269/315; 269/55; 83/438

(57) ABSTRACT

A panel is slidable on a table saw by means of a roller assembly which is mounted in a groove in the working surface of the table saw. The panel has two parallel tracks for a pair of fence retainers. The retainers are pivotally connected to a fence and at least one is slidable relative to the fence. The retainers may be immobilized in the tracks and also immobilized relative to the fence. A fence stop supports a work piece on the fence. The fence stop has a head to which an arm is connected. The arm pivots toward and away from a work-piece contacting position. The head may be turned upside down and whether it is upright or upside down determines the distance between the work-piece contacting position and the fence.

### FIELD OF THE INVENTION

This invention relates to a working surface for use in conjunction with any machine or workbench on which mechanical or practical working can be carried out. More particularly the invention relates to a working surface which may be provided with tracks for a fence and may be sliding. The working surface may be used in conjunction with a workbench or a machine such as a table saw, router table, shaper, drill press, band saw or workbench.

### BACKGROUND OF THE INVENTION

In my U.S. Pat. No. 7,337,701 B2 issued on Mar. 4, 2008 and my co-pending application for a U.S. Pat. Ser. No. 11/486,023 filed on Jul. 14, 2006, I describe sliding tables which have means for accurately guiding the movement of the table and minimizing rocking of the table on their longitudinal and transverse axes. The sliding tables include, among other things, a movable carriage on which a piece of working is located. The tables also include guide rods or spring-loaded rollers for accurately guiding the tables while they are sliding so that precise working can be carried out on them.

This application is directed to a working surface which has tracks for a fence. The tracks are arranged such that a fence can be oriented in a wide variety of positions to significantly increase the versatility of the working surface over conventional working surfaces for doing mechanical or practical working. The subject working surface may or may not be slidable.

This application is also directed to the fence to which a sub-fence can be added for added versatility of the working surface.

### SUMMARY OF THE INVENTION

Briefly, the sliding table of my invention includes a roller assembly adapted to be immobilized relative to a working upper wall. The assembly includes not only rollers but also a bed having a track on its lower wall for the rollers. The bed is movable relative to the roller assembly

The working surface includes a panel adapted to receive a work piece. The panel has spaced apart first and second tracks and first and second fence retainers each being movable along the first and second tracks respectively. Each fence retainer is pivotally connected to the fence. At least one of the fence retainers is slidable relative to the fence. First immobilizing means are provided for selectively immobilizing the fence retainers relative to the tracks and second immobilizing means are also provided for selectively preventing the slidable fence retainer from sliding relative to the fence.

A fence stop supports a work piece on the fence. The fence stop includes a head having obverse and reverse walls and invertible from an obverse position in which the obverse wall is uppermost to a reverse position in which the reverse wall is uppermost. An arm is connected to the head and pivots about an axis toward and away from a work-piece contacting position. The arm has a surface which is adapted to contact the work-piece and which, when in the work-piece contacting position, faces toward the front wall of the fence. Means is provided for connecting the head to the fence such that the space between the axis and the surface, when the arm is in the work-piece contacting position, is greater when the head is in the obverse position than when the head is in the reverse position.

### DESCRIPTION OF THE DRAWINGS

The working surface of the invention is described with reference to the accompanying drawings in which:

FIG. 1 is a perspective view of the working surface which slides. The working surface is shown in conjunction with a table saw;

FIG. 2 is a plan view of the sliding working surface and table saw;

FIG. 3 is another plan view similar to that of FIG. 2 except that the sliding working surface is to the right of the working surface illustrated in FIG. 2;

FIG. 4 is a perspective view of a roller assembly;

FIG. 5 is a perspective view of the panel of the working surface;

FIG. 6 is a section of the roller assembly in conjunction with an upper wall of the table saw;

FIG. 7 is a perspective view of the panel of the working surface;

FIG. 8 is perspective view of a first fence retainer in conjunction with a portion of a fence;

FIG. 9 is an elevation of the fence retainer and fence illustrated in FIG. 8;

FIG. 10 is a perspective view of a second fence retainer and a portion of a fence;

FIGS. 11 and 12 are perspective views of a fence stop in obverse and reverse positions together with a portion of a fence; and

FIGS. 13 and 14 are plan views of the panel, both embodiments of the fence retainers and the fence.

Like reference characters refer to like parts throughout the description of the drawings.

### DESCRIPTION OF PREFERRED EMBODIMENTS

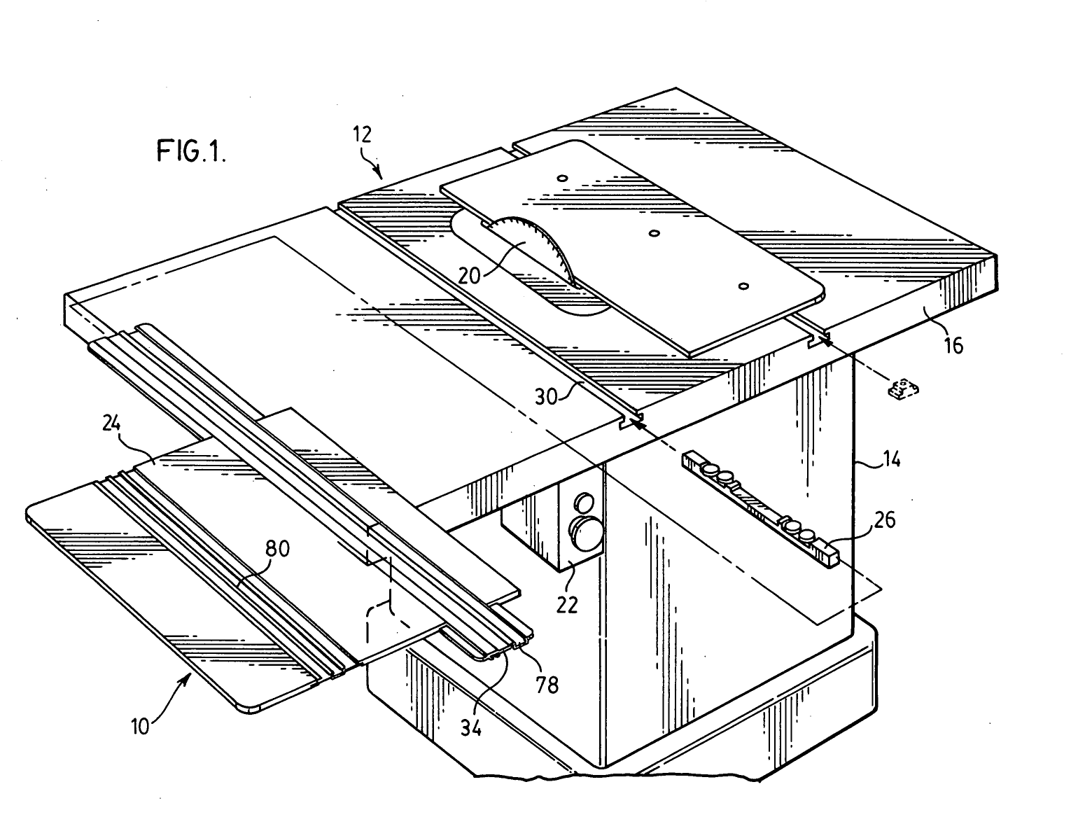

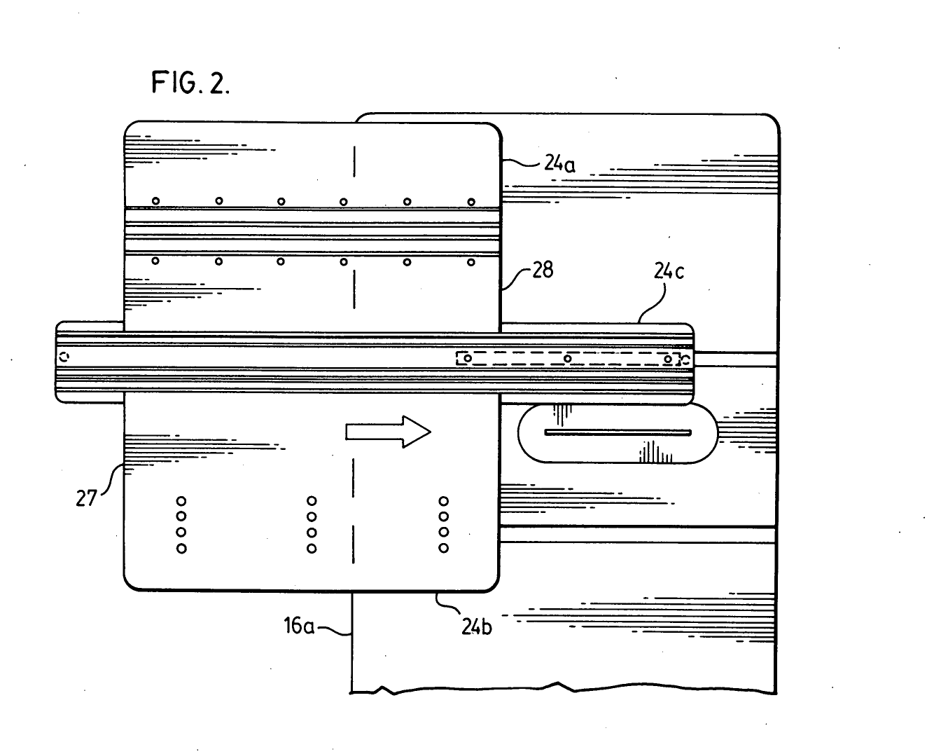

With reference to FIGS. 1 and 2, the working surface of the invention, generally 10, is shown in conjunction with a table saw, generally 12. The table saw is conventional and consists of a housing 14 and an upper wall 16 through which a circular saw blade 20 projects. An electrical box 22 having on-off switches which control the operation of the saw.

The working surface includes a sliding panel 24 and a roller assembly 26. The panel is composed of two flat segments 24a, b and a track bed 24c. The two segments 24a,b are located on opposite sides of the track bed 24c and are integral with it. The upper wall of the two segments is flush with the upper wall of the track bed.

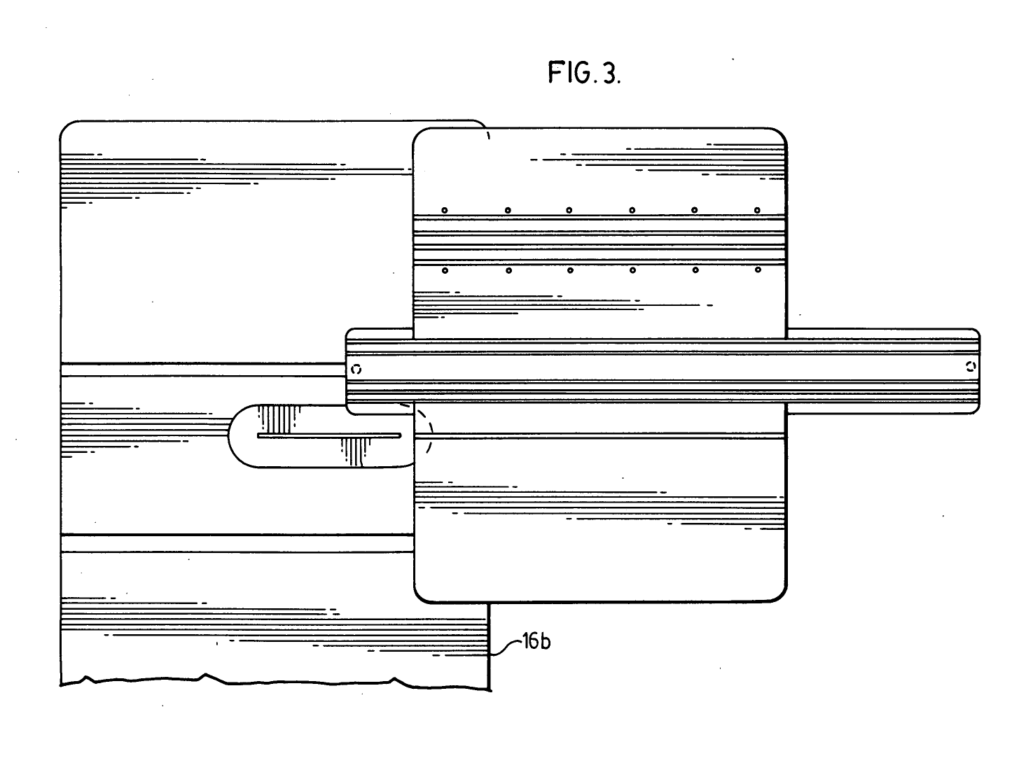

The track bed extends beyond the forward and rear edges 27, 28 of the panel segments so that the panel is movable forward of the front wall 16a of the table saw as illustrated in FIG. 2. Likewise the panel is movable to the rear wall 16b of the table saw as illustrated in FIG. 3.

### Roller Assembly

With reference to FIGS. 1, 4 and 6, the lower portion of the roller assembly is fixed in a T-slot 30 in the upper wall 16 of the table saw. The upper portion of the roller assembly is received in a track or groove 34 in the lower wall of the track bed.

The roller assembly includes an elongated bar 40 and rollers 42. The bar is removably secured in T-slot 30 by means of threaded screws 46 which pass through three openings 48, one adjacent to each end of the bar and a third at the centre of the bar. The screws engage hexagonal nuts 50 located in recesses 52 in the lower wall of the bar.

The hexagonal nuts are larger than the upper portion 30a of the T-slot so that the bar cannot be lifted out of the slot once the screws are tightened to the hexagonal nuts. The nuts are however smaller than the lower portion 30b of the T-slot so that the nuts fit into the slot.

A pair of set screws 60 on opposite sides of each opening 48 of the bar is provided to fix the bar tightly in the T-slot. When the set screws are tightened, their lower ends come into contact with the lower wall of the T-slot. Further tightening of the set screws causes the upper walls of the hexagonal nuts into contact with the upper wall of the lower portion of the T-slot. The bar is then firmly fixed in the slot.

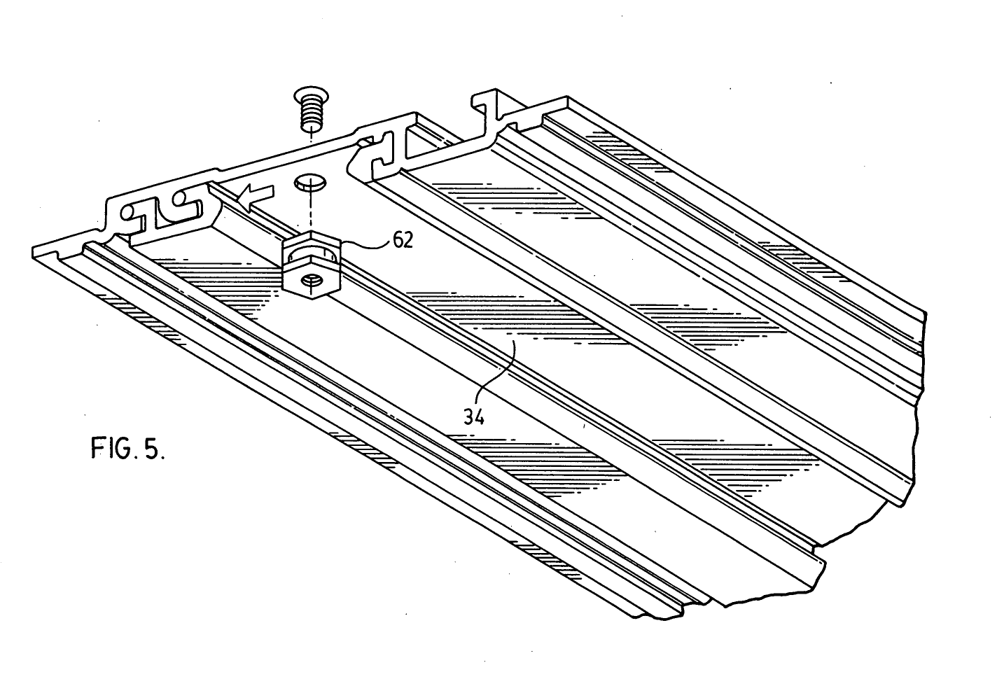

As illustrated in FIG. 5, hexagonal bolts 62 are attached at both ends of the sliding table and prevent the table from sliding off the roller assembly. The bolts accordingly limit longitudinal movement of the table at both ends of its stroke bar.

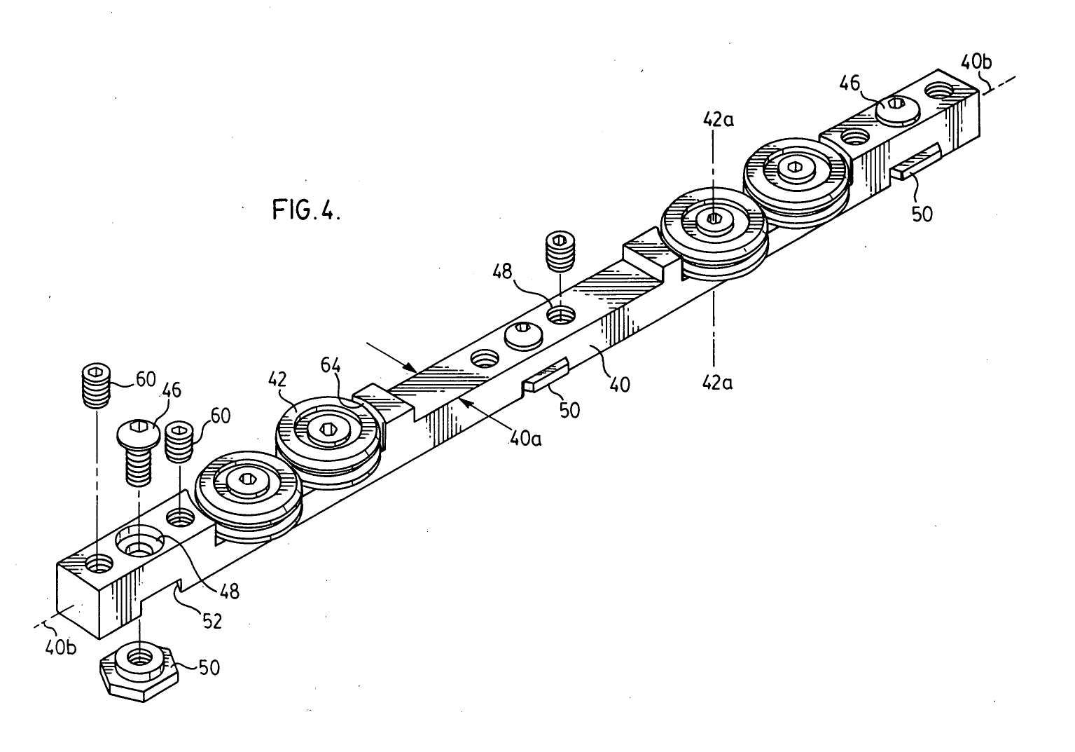

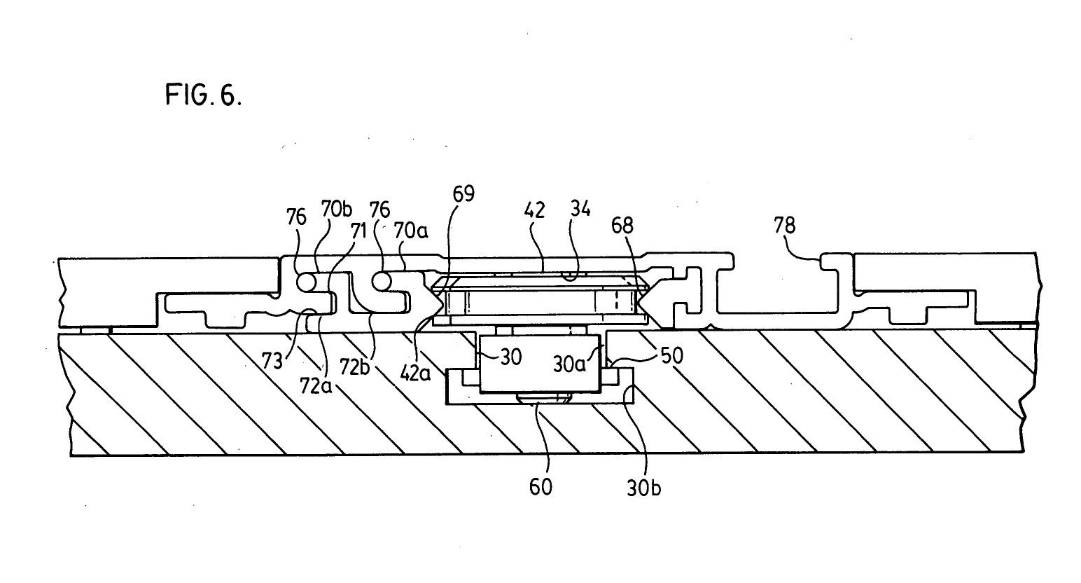

With reference to FIGS. 4 and 6, the width 40a of the bar is slightly less than the width of the upper portion of the T-slot so that the bar can be easily removed from the T-slot when screws 46 are removed from the hexagonal nuts.

Rollers 42 are arranged in pairs and each pair is located in a separate recess 64 in the upper wall of the bar. The axes of rotation 42a-42a of the rollers are offset from the centre line 40b-40b or longitudinal axis of the bar. In each pair of rollers, their axes of rotation are on opposite sides of the centre line.

With reference to FIGS. 5 and 6, the rollers are received in track 34 which is downwardly opening and longitudinal extending. The track is formed in the lower wall of track bed 24c and is defined by spaced apart V-shaped side walls 68, 69 which are received in annular grooves 42a in the rollers. Side wall 68 is pressure fit in a slot formed in the lower structure of the track bed and is immovable. By contrast, side wall 69 is movable. The latter wall has upper horizontally spaced limbs 70a, b which are received in grooves in the lower structure and are slidable therein. The extent of sliding is however restricted by limbs 72a,b in the lower structure which are received in slots 73 in the side wall.

O-ring cord stock 76 is received in the space between the forward ends of limbs 70a,b and the facing walls of slots 71 in the side wall. The cord stock serves to resiliently bias the side wall 69 into the annular grooves in the rollers.

The cord stock puts lateral pressure on the rollers which are closer to side wall 69 in each pair with resulting lateral pressure on the roller assembly. Such pressure forces the other roller in each pair into the other side wall 68 since they are closer to the latter side walls. The resilient biasing of the cord stock results in pressure being applied by both side walls 68,69 on the rollers in each pair. Such pressure results in less sideways movement or rocking of the panel as it slides longitudinally in track 34.

### Tracks in the Working Surface

With reference to FIGS. 1 and 6, an upwardly opening T-slot 78 defines an upwardly opening first track in the sliding panel. The latter track is adjacent to downwardly opening track 34 and the two tracks run parallel to each other. An upwardly opening second track 80 is also formed in the sliding panel. That track runs parallel to the other two tracks 34, 78.

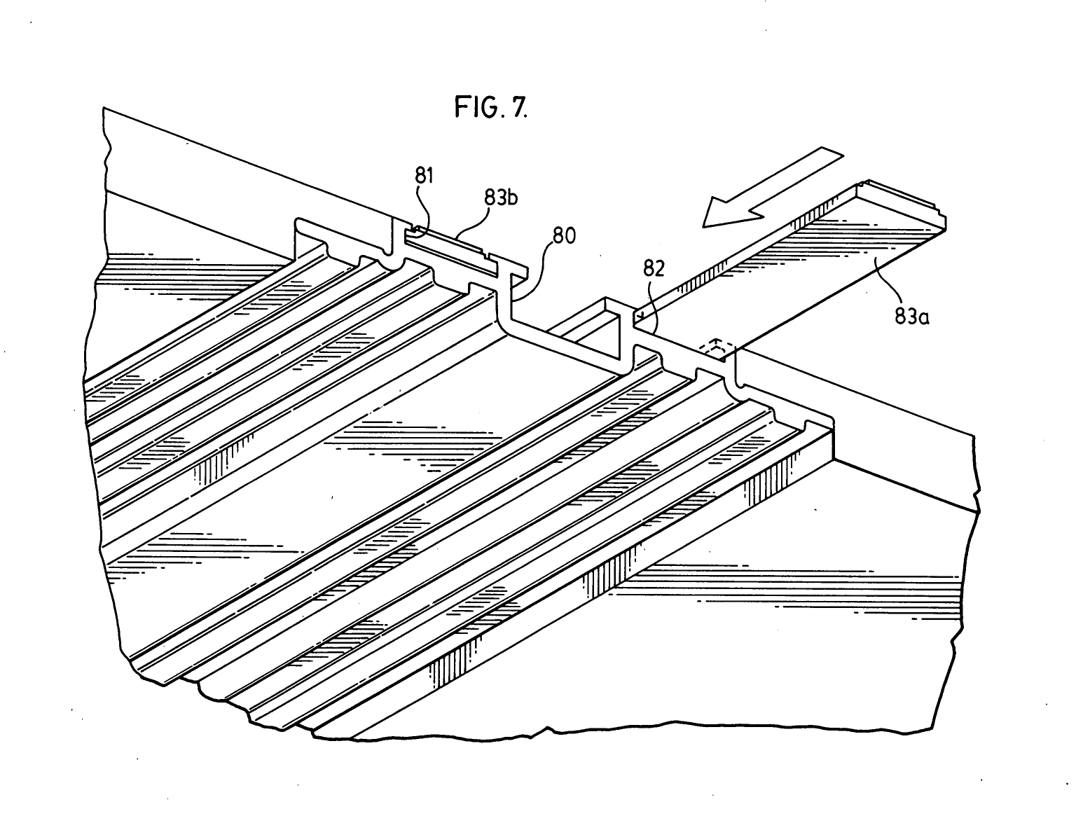

With reference to FIG. 7, track 80 is defined by a central upwardly opening T-slot and receives a retainer for a fence. Shallower T-slots 81, 82 are formed on either side of the track. The shallower T-slots receive elongated slats 83a,b on which graduated scales are imprinted. The slats and graduated scales are described in more detail below.

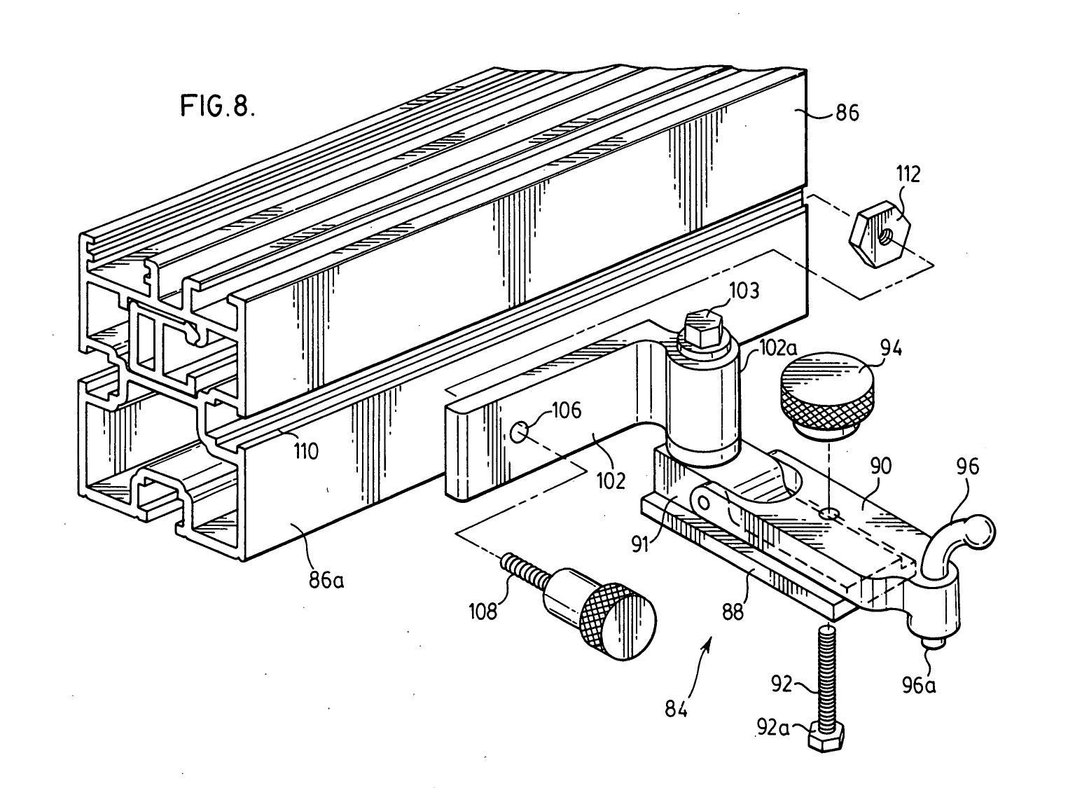

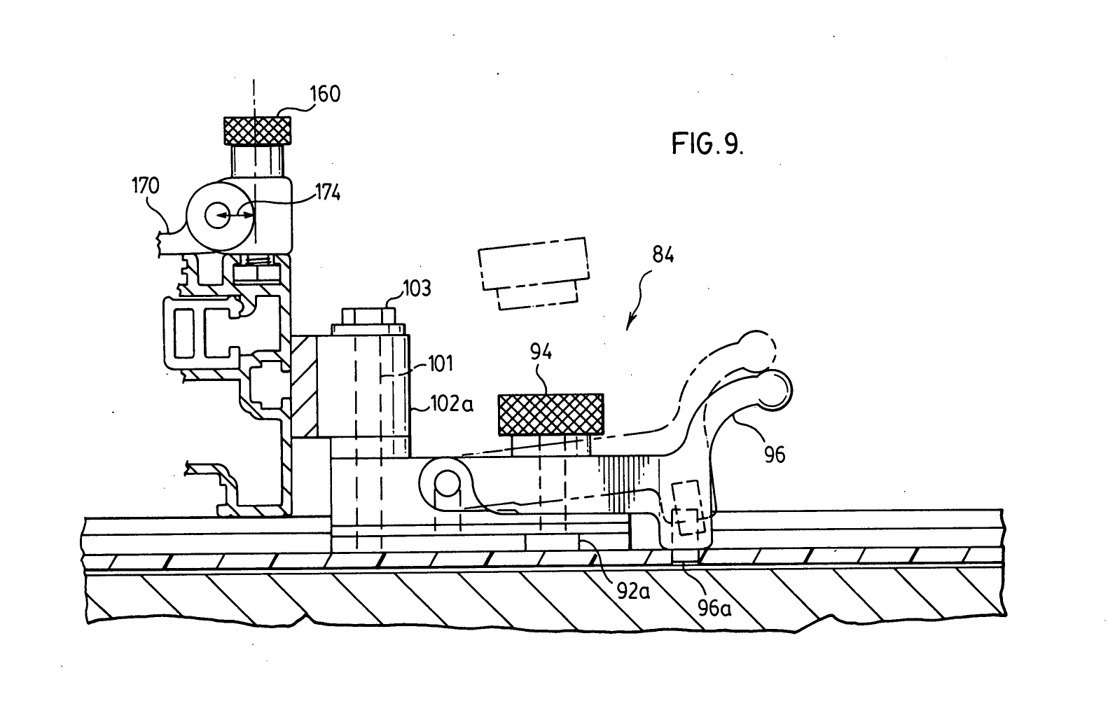

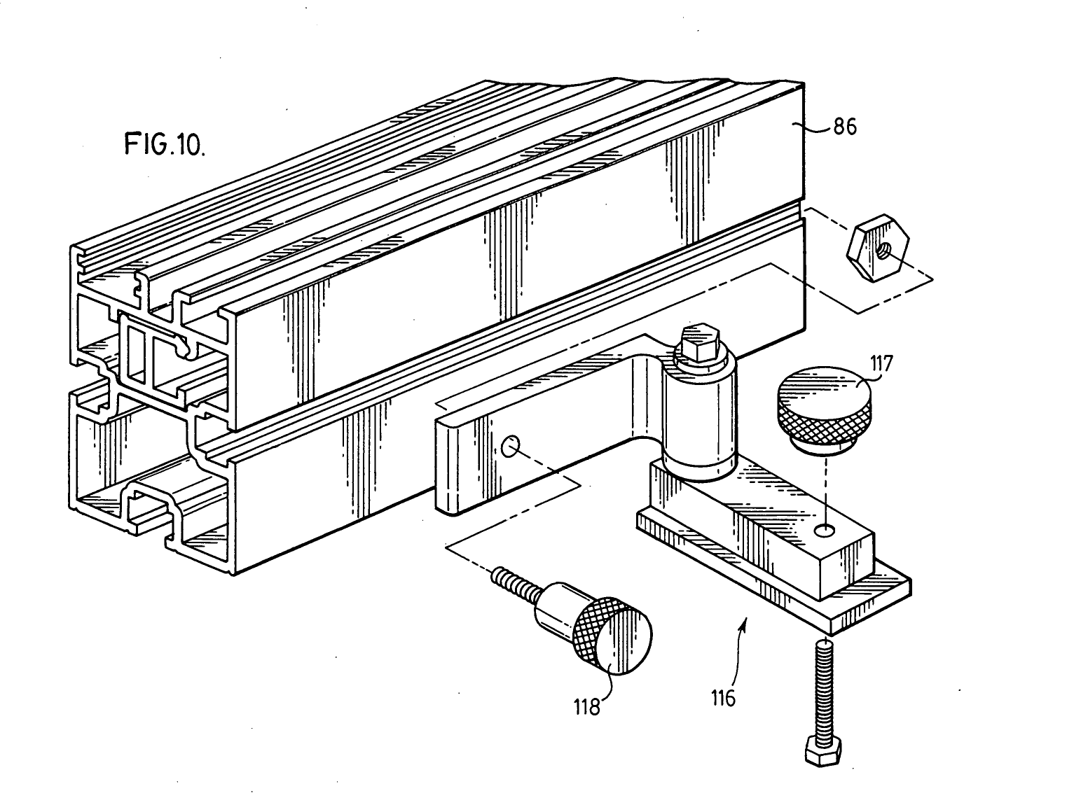

The fence retainer received in track 78 is illustrated in FIGS. 8 and 9 and the fence retainer received in track 80 is illustrated in FIG. 10. The former fence retainer is sometimes referred to as the “first fence retainer” below and the latter fence retainer is referred to as the “second fence retainer”.

With reference first to FIGS. 8 and 9, and also FIG. 6, the first fence retainer, generally 84, is shown connected to fence 86. The retainer has a lower flange 88 and an upper arm 90 which pivots about a pedestal 91. Flange 88 fits into the lower portion of the T-slot which defines track 78 while the arm is above the track.

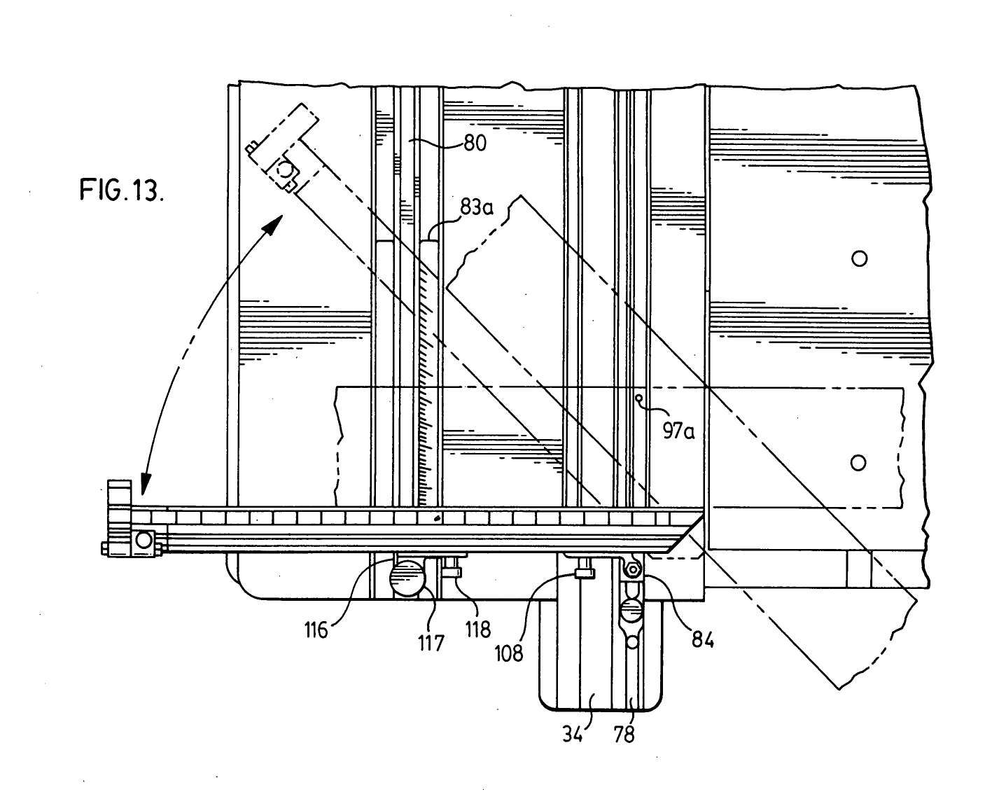

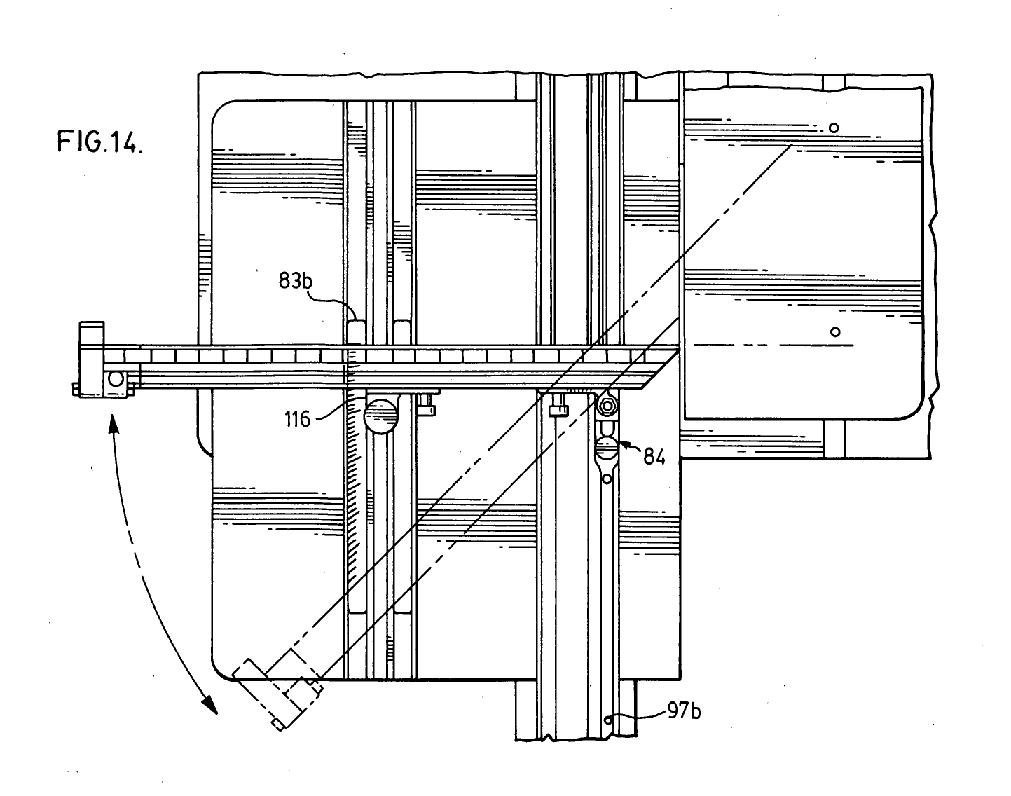

A hexagonal bolt 92 has a head 92a which is recessed into the underside of the flange. The bolt extends upwardly through the flange and plate and into threaded engagement with a knurled knob 94. A pin 96 is formed at the forward end of the upper arm. A boss 96a is formed on the lower end of the pin and is adapted to be received in one or the other of two apertures 97a,b formed in the bed of track 78. The apertures are illustrated in FIGS. 13 and 14 respectively and constitute so called “stop points” for the fence retainer.

The fence retainer is movable along track 78 until boss 96a is vertically above either aperture 97a or 97b. Tightening of knob 94 causes arm 90 to descend and as it does so, causes boss 96a to enter the aperture with resulting immobilization of the fence retainer. Further tightening of knob 94 results in squeezing of the upper wall of the track or T-slot 78 by flange 88 and arm 90.

The boss serves to locate the fence retainer while knob 94 and hexagonal bolt 92 which it engages serve to positively immobilize the fence retainer at the stop point. Loosening of the knob, of course, permits the fence retainer to move in the track. The bolt, nut and knob constitute a so-called “first immobilizing means” while the boss constitutes a locating means.

The pedestal of the fence retainer is pivotally connected to a panel 102 by a pin 101 which is fixed to the pedestal and which extends upwardly through the central bore of a cylinder 102a at one end of the panel. The pin is held in the cylinder by nut 103.

Panel 102 contacts the front wall 86a of the fence. An aperture 106 is formed in the panel for receipt of a thumbscrew 108 which extends through the aperture and into a T-slot 110 formed on the front wall of the fence. The T-slot extends the length of the fence.

The inside end of the bolt is threadably connected to a hexagonal nut 112 which slides in the slot. The head of thumbscrew 108 facilitates manual tightening of the bolt until the nut squeezes against the inside wall of the T-slot and immobilizes the fence relative to the fence retainer. Loosening the bolt allows the fence to move relative to the fence retainer. The thumbscrew and nut constitute a so-called “second immobilizing means”.

Boss 96a and apertures 97a,b cooperate to accurately locate the fence retainer and the corresponding pivot point of pin 101. It is only possible to immobilize the fence retainer at the two stop points defined by the apertures. Should an attempt be made to immobilize the fence retainer elsewhere, boss 96a will prevent that. It does so by coming into contact with the bottom wall of the T-slot which defines track 78 when knob 94 is tightened. Flange 88 and arm 90 will not be close enough to the upper wall of the T-slot to squeeze it at this time and the fence retainer will not be immobilized.

With reference to FIGS. 7 and 14, the graduated scales on slats 83a,b on either side of track 80 are calibrated to indicate the angle between the front face 86a of the fence and the centre line of track 78 on which the pivot point of pin 101 of fence retainer 84 is located.

In FIG. 13, the fence is shown with the fence retainer in a forward position and with the boss engaged in the forward aperture 97b. The angle of the front wall of the fence can be read off the graduated scale on slat 83a. In FIG. 14, the fence is shown in a rearward position in which the boss is in aperture 97a. In this Figure, the angle of the front wall of the fence is read off the scale on slat 83b.

It will be understood that the fence functions in two ways: in the forward position illustrated in FIG. 13, the fence can be rotated clockwise from an angle of approximately 90 degrees to approximately 45 degrees relative to the longitudinal axis of track 78. In the rearward position illustrated in FIG. 14, the fence can be rotated counterclockwise from an angle of approximately 90 degrees to approximately 45 degrees relative to the longitudinal axis of the track.

In the forward position, the angle of cut can be adjusted clockwise from a maximum to a minimum whereas in the rear position, the angle can be adjusted counter clockwise from a maximum to a minimum.

With reference to FIG. 10, a second fence retainer, generally 116, is of the same construction as the first fence retainer 84 of FIGS. 8 and 9 except that it lacks a pivoting arm. The second fence retainer 116 is immobilized by means of knob 117 which functions in the same way as knob 92 in fence retainer 84. Thumbscrew 118 has the same function as thumbscrew 108 in fence retainer 84 and as previously indicated, fence retainer 116 slides in track 80.

### Fence Stop

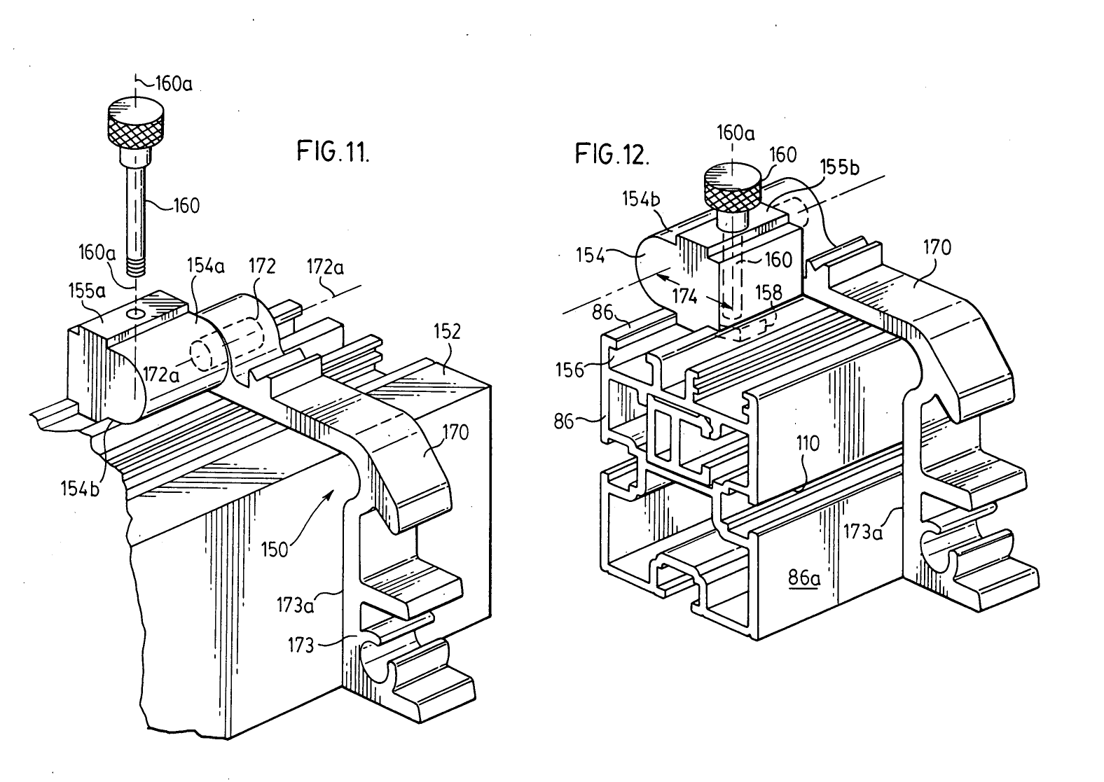

With reference to FIGS. 11 and 12, fence stop, generally 150, abuts against the back side of a work piece while the front of the work piece abuts against the front wall 86a of the fence, or, as described below, the front face of a sub-fence 152.

The fence stop has a head 154 which has a ridge 155a,b on its obverse and reverse walls 154a,b respectively. Depending on whether the head is right side up or upside down, each ridge fits into the upper opening of a T-slot 156. The T-slot runs longitudinally along the upper wall of the fence

Whichever ridge faces downward is held in the T-slot by the combination of hexagonal nut 158 which slides in the T-slot and a thumbscrew 160. The thumbscrew is oriented vertically about axis 160a-160a and extends downwardly through a cylindrical opening in the head and into threadable engagement with the nut. Tightening of the thumbscrew causes the nut to rise into contact with the inner wall of the T-slot with resulting immobilization of the head relative to the fence.

The head of the fence stop is invertible from the position illustrated in FIG. 11 in which its obverse wall 154a is uppermost to the position illustrated in FIG. 12 in which its reverse wall 154b is uppermost. The head is invertible simply by unscrewing thumbscrew 160 in order to disconnect its lower end from nut 158. Head 154 is then removed from the thumbscrew and is turned upside down and the thumbscrew is reinserted through the opening in the head and is reattached to nut 158.

An arm 170 is pivotally mounted to one side of the head. The arm pivots about a pintle 172 having an axis 172a-172a which is parallel to the longitudinal axis of the fence and normal to the axis 160a-160a of the thumbscrew. The axes of the thumbscrew and the pintle do not intersect but are offset from each other. The extent of the offset is marked 174 in FIGS. 12 and 9.

Arm 170 has a lower portion 173 which has an inner surface 173a which faces toward the front wall 86a of the fence against which a work piece abuts. The distance between the inner surface of the arm and the front wall of the fence varies according to which wall of head 154 is uppermost. When its obverse wall is uppermost as illustrated in FIG. 11, the distance is greater than when its reverse wall is uppermost as illustrated in FIG. 12.

The distance varies according to which wall of the head is uppermost because of the offset between the axes of the thumbscrew and pintle. In FIG. 12, the pintle is behind the thumbscrew while in FIG. 11, it is in front of the thumbscrew. When the arm rotates about the pintle as shown in FIG. 12, the inner surface of the arm will be relatively close to the front wall of the fence. By contrast when the arm rotates about the pintle as shown in FIG. 11, its inner surface will be relatively far apart from the front wall of the fence.

When the fence stop is in the position illustrated in FIG. 11, there is room for the sub-fence 152. The sub-fence is attached to fence 86 by means of screws and nuts (not illustrated). The screws pass inwardly through openings in the sub-fence, into T-slot 110 and, like thumbscrew 108 in FIG. 8, threadably engage nuts in the slot.

A sub-fence is useful to prevent a fence from being damaged while a work piece is being cut. In the absence of a sub-fence, an operator would normally position a fence no closer than about ⅛th of an inch from a blade to prevent the blade from cutting into the fence. However when the fence is spaced apart from the blade, the work piece is not supported on its back side and the cut in the work piece is usually not smooth but is uneven and splintered. This problem is generally referred to as “tear-out” and is eliminated by a sub-fence.

With reference to FIG. 11, sub-fence 152 which is attached to the fence abuts the fence on the side closest to the blade. The sub-fence can be positioned such that there is no space between the sub-fence and the blade. When the work piece abuts the sub-fence in this position, the cut in the work piece is smooth and free from splinters. While the sub-fence is or may be damaged by the blade, the fence is protected by the sub-fence and is not damaged.

Fence stop 150 gives an operator the option of using a sub-fence or not. When a sub-fence is used, the position of the fence stop is as illustrated in FIG. 11 and when a sub-fence is not used, the position of the fence stop is as illustrated in FIG. 12.

With reference to FIG. 13, fence retainer 84 is located in the forward position with the boss 96a located in forward aperture 97b. The fence can be moved from the position illustrated in solid lines to the position illustrated in broken lines by loosening knob 117 and thumbscrew 118 of fence retainer 116 and sliding the latter retainer along track 80 toward the rear edge of the panel. As the latter fence retainer slides, the fence will rotate clockwise about the two fence retainers. As the fence rotates, the position of the work piece will change from a position in which the retainer is normal to tracks 80, 34 to an angular position relative to the two tracks as shown in broken lines in the Figure.

With reference to FIG. 14, fence retainer 84 is located in the rear position and boss 96a is located in rear aperture 97a. The fence can be moved from the position illustrated in solid lines to the position illustrated in broken lines by loosening knob 117 and thumbscrew 118 of fence retainer 116 and sliding the latter retainer toward the front edge of the panel. As the retainer slides, the fence will rotate counter-clockwise about the two fence retainers and the position of the work piece will change from a normal horizontal position to the angular position relative to the two tracks as shown in broken lines in the Figure.

It will be understood, of course, that modifications can be made in the structure of the working surface and other components of the invention as described herein without departing from the scope and purview of the invention as defined in the appended claims.

I claim:

1. In combination, a fence and a panel adapted to receive a work piece, said panel having spaced apart first and second tracks; first and second fence retainers each being movable along said first and second tracks respectively, each said fence retainer being pivotally connected to said fence, at least one of said fence retainers being slidable relative to said fence; first immobilizing means for selectively immobilizing each said fence retainer relative to said tracks; and second immobilizing means for selectively preventing said slidable fence retainer from sliding relative to said fence.

2. The combination as claimed in claim 1 wherein said first fence retainer is movable between spaced apart stop points on said first track, said first immobilizing means for immobilizing said first fence retainer operative to cause selective immobilization at each said stop point but otherwise inoperative between said stop points.

3. The combination of claim 2 further including a pair of graduated scales each for measuring the angle of said fence at such time as said first retainer is at a separate said stop point.

4. The combination of claim 3 wherein each said graduated scale is adapted to measure the angle of said fence as said fence rotates separately clockwise and counterclockwise, respectively, toward said first track

5. In combination, a fence and a panel adapted to receive a work piece, said panel having spaced apart first and second tracks; first and second fence retainers each being movable along said first and second tracks respectively, each said fence retainer being pivotally connected to said fence, at least one of said fence retainers being slidable relative to said fence; first immobilizing means for selectively immobilizing said second fence retainer relative to said tracks; and second immobilizing means for selectively preventing said slidable fence retainer from sliding relative to said fence. said first track having a pair of stop points spaced along said first track, said first fence retainer having an arm pivotal between immobilizing and mobilizing positions, said arm having a boss which is adapted to be received in either of said aperture and upon such receipt, said arm is in said immobilizing position with resulting immobilization of said first fence retainer relative to said fence.

6. The combination of claim 1 wherein said first and second tracks are parallel to one another.

7. The combination of claim 1 wherein both said fence retainers are slidable relative to said fence and wherein said second immobilizing means selectively prevents said second fence retainer from moving along said second track.

8. A fence stop for a fence having a front wall against which a work piece is adapted to abut, said fence stop including: a head having obverse and reverse walls and invertible from an obverse position in which said obverse wall is uppermost to a reverse position in which said reverse wall is uppermost; an arm connected to said head and pivoting about an axis toward and away from a work piece contacting position, said arm having a surface which is adapted to contact the work piece and which, when in said work piece contacting position, faces toward said front wall; and means for connecting said head to said fence such that the space between said axis and said surface, when said arm is in said work piece contacting position, is greater when said head is in said obverse position than when said head is in said reverse position.

9. A fence stop for a fence having a front wall against which a work piece is adapted to abut, said fence stop including: a head having obverse and reverse walls and invertible from an obverse position in which said obverse wall is uppermost to a reverse position in which said reverse wall is uppermost; means for connecting said head to said fence when said head is in said obverse position and when said head is in said reverse position, an arm connected to said head and pivoting about an axis toward and away from a work piece contacting position, said arm having a surface which is adapted to contact said work piece and which, when said arm is in said work piece contacting position, faces toward said front wall, said axis being spaced apart from said surface a greater distance when said head is in said obverse position than when said head is in said reverse position.

10. The fence stop of claim 9 wherein said connecting means is selectively movable relative to said fence.

11. The fence stop of claim 8 wherein said connecting means is a pin having means for mounting to said fence, said head having an opening for receipt of said pin.

12. The fence stop of claim 11 wherein said pin is rotatable relative to said fence, said pin having a knob for facilitating such rotation, said knob bearing down on said head upon rotation thereof in one direction with resulting immobilization of said head relative to said fence.

13. A sliding working surface for guiding a work piece and adapted for use in conjunction with a workbench or machine having an upper wall, said sliding working surface comprising: a roller assembly adapted to be immobilized relative to said upper wall and having rollers; and a panel having oppositely facing upper and lower walls, said lower wall having a track for said rollers such that said panel is movable relative to said roller assembly.

14. The sliding working surface of claim 13 wherein said track has a pair of spaced apart side walls between which said rollers are received, said rollers being arranged in pairs, one said roller in each said pair being closer to one said side wall than the other roller in said pair while said other roller is closer to the other said side wall than said one roller.

15. The sliding working surface of claim 14 further including resilient means for biasing one of said side walls toward said rollers

16. The sliding working surface of claim 14 wherein said resilient means is O-ring cord stock.
